(19) United States
(12) Patent Application Publication
(10) Pub. No.: US 2012/0077569 A1
(43) Pub. Date: Mar. 29, 2012

(54) WAGERING GAME, GAMING MACHINE, GAMING SYSTEM, AND METHOD WITH AN EMBEDDED BONUS GAME

(75) Inventors: Brian Alexander Watkins, Austin, TX (US); Steven E. Meyer, Austin, TX (US); Clint A. Owen, Austin, TX (US); JP Cody, Austin, TX (US)

(73) Assignee: Multimedia Games, Inc., Austin, TX (US)

(21) Appl. No.: 13/250,787

(22) Filed: Sep. 30, 2011

Related U.S. Application Data
(63) Continuation-in-part of application No. 13/195,037, filed on Aug. 1, 2011.
(60) Provisional application No. 61/371,532, filed on Aug. 6, 2010.

(51) Int. Cl. A63F 13/00

(52) U.S. Cl. 463/25

(57) ABSTRACT

A method of operating a gaming machine includes receiving one or more primary game inputs through the gaming machine to initiate one or more plays of a primary game. After the one or more plays of the primary game, a feature game is initiated and presented at the gaming machine through a display device included with the gaming machine. In response to a triggering event in the feature game and prior to completion of the feature game, the method further includes initiating an embedded bonus game and presenting the embedded bonus game through the display device. Upon completion of the embedded bonus game, the method continues with presenting a remainder of the feature game. The method further includes awarding a total prize for the feature game and embedded bonus game. The total prize is made up of a feature game prize component obtained in the presentation of the feature game and an embedded bonus game prize component obtained in the presentation of the embedded bonus game.

### CROSS-REFERENCE TO RELATED APPLICATIONS

This application is a continuation-in-part of U.S. patent application Ser. No. 13/195,037, filed Aug. 1, 2011, and entitled “Wagering Game, Gaming Machine, Gaming System and Method With A Player-Determinable Feature Game Aspect.” The Applicants claim the benefit of this earlier nonprovisional patent application under 35 U.S.C. §120. The entire content of this nonprovisional application is incorporated herein by this reference.

The Applicants also claim the benefit, under 35 U.S.C. §119(e), of U.S. Provisional Patent Application No. 61/371,532 filed Aug. 6, 2010, and entitled “Wagering Game, Gaming Machine, Gaming System and Method With A Player-Determinable Feature Game Aspect.” The entire content of this provisional application is incorporated herein by this reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent files or records, but otherwise reserves all rights of copyright whatsoever.

### BACKGROUND OF THE INVENTION

1. Field of the Invention

This invention relates to wagering games, gaming machines, gaming systems, and associated methods. More particularly, the invention relates to gaming machines and related methods presenting wagering games together with either a community or stand-alone feature game with an embedded bonus game.

2. Description of the Related Art

Various gaming systems have been developed to provide wagering games and community or stand-alone feature games. These “feature” games comprise secondary or bonus games that are offered in addition to a primary or base game offered at the given gaming machine. There continues to be a need for new and distinctive wagering game presentations which provide both a primary game and a feature game.

### SUMMARY OF THE INVENTION

A method of operating a gaming machine according to one form of the present invention includes receiving one or more primary game inputs through the gaming machine to initiate one or more plays of a primary game presented at the gaming machine. After the one or more plays of the primary game are presented at the gaming machine, the method includes initiating a feature game and presenting the feature game at the gaming machine through a display device included with the gaming machine. In response to a triggering event in the feature game and prior to completion of the feature game, the method further includes initiating an embedded bonus game and presenting the embedded bonus game through the display device. In some implementations of the present invention, the presentation of the embedded bonus game is visually distinct from the presentation of the feature game such that it is readily apparent to the player that the embedded bonus game is a different game from the feature game. Upon completion of the embedded bonus game, the method continues with presenting a remainder of the feature game through the display device. The method further includes awarding a total prize for the feature game and embedded bonus game. The total prize is made up of a feature game prize component obtained in the presentation of the feature game and an embedded bonus game prize component obtained in the presentation of the embedded bonus game.

The present invention also encompasses a gaming system which may be implemented as a standalone gaming machine, or a gaming machine connected in a network. Such a gaming system in one form or the invention includes one or more display devices, a player input system, at least one processor, and at least one memory device storing instructions executable by the at least one processor. The instructions are executable by the at least one processor to receive one or more primary game inputs through the player input system to initiate one or more plays of the primary game, and then, after the one or more plays of the primary game, initiate the feature game so that an initial portion of the feature game is presented through at least one of the one or more display devices. The instructions are also executable to initiate the embedded bonus game so that the embedded bonus game is presented through the at least one of the one or more display devices, and upon completion of the embedded bonus game, cause a remainder of the feature game to be presented through the at least one of the one or more display devices. The stored instructions are also executable to cause the total prize to be awarded for the feature game and embedded bonus game.

Considering that some forms of the present invention are implemented through a gaming system including one or more general purpose processors, the present invention also encompasses a program product stored on one or more tangible data storage devices. Such a program product may include player input program code, primary game program code, embedded game program code, and feature game program code. The player input program code is executable to receive primary game inputs through the gaming system, while the primary game program code is executable to initiate one or more plays of a primary game in response to each respective primary game input. The embedded bonus game program code is executable to present the embedded bonus game and the feature game program code is executable to present the feature game and then award the total prize for the feature game and embedded bonus game.

These and other advantages and features of the invention will be apparent from the following description of illustrative embodiments, considered along with the accompanying drawings.

### BRIEF DESCRIPTION OF THE DRAWINGS

FIG. 1A illustrates an example gaming system providing a community feature game with ball launching as shown on an overhead display connected to a bank of gaming machines in accordance with one or more embodiments.

FIG. 1B illustrates an example community feature game with a previously launched ball deflecting from a small bumper impact as shown on an overhead display in accordance with one or more embodiments.

FIG. 1C illustrates an example community feature game with several balls deflecting along respective paths down to an exit as shown on an overhead display in accordance with one or more embodiments.

FIG. 2 illustrates an example flowchart for the conduct of a community feature game in accordance with one or more embodiments.

FIG. 3 illustrates an example display arrangement on the front of a gaming machine whereby a qualified player may launch a virtual object or projectile on an overhead display to accumulate community feature game awards in accordance with one or more embodiments.

FIG. 4 illustrates a front perspective view of an example gaming machine connectable with a bank of gaming machines and an overhead display to participate in a community feature game in accordance with one or more embodiments.

FIG. 5 illustrates an example logic diagram of an example gaming machine in accordance with one or more embodiments.

FIG. 6 illustrates an example block diagram of an example gaming network in accordance with one or more embodiments.

FIG. 7 is an example flowchart for the conduct of a web-based community feature game.

FIG. 8 is a flow chart showing an embedded game process according to one implementation of the present invention.

FIG. 9 is representation of a primary game graphic display in a configuration which represents a trigger for a feature game in accordance with embodiments of the present invention.

FIG. 10 is a representation of a primary game graphic display in an example feature game messaging configuration.

FIG. 11 is a representation of an alternate configuration of a feature game graphic display.

FIG. 12 is a representation of another alternate configuration of a feature game graphic display.

FIG. 13 is a representation of another alternate configuration of a feature game graphic display.

FIG. 14 is a representation of another alternate configuration of a feature game graphic display.

FIG. 15 is a representation of an embedded bonus game graphic according to the present invention.

FIG. 16 is a representation of another embedded bonus game graphic according to the present invention.

### DESCRIPTION OF ILLUSTRATIVE EMBODIMENTS

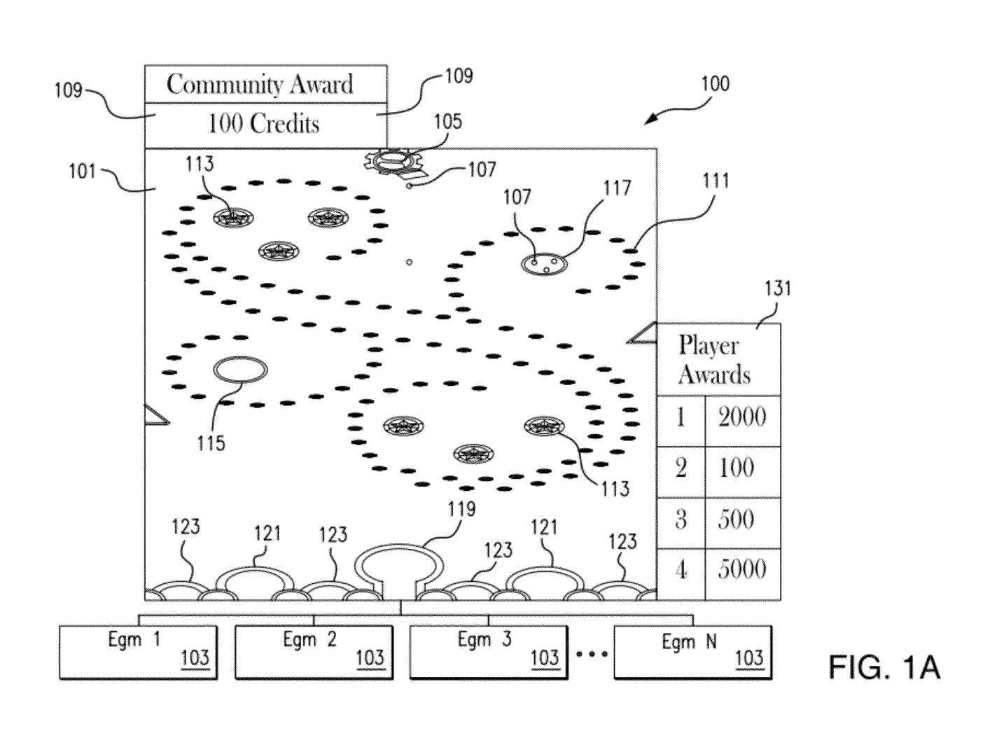

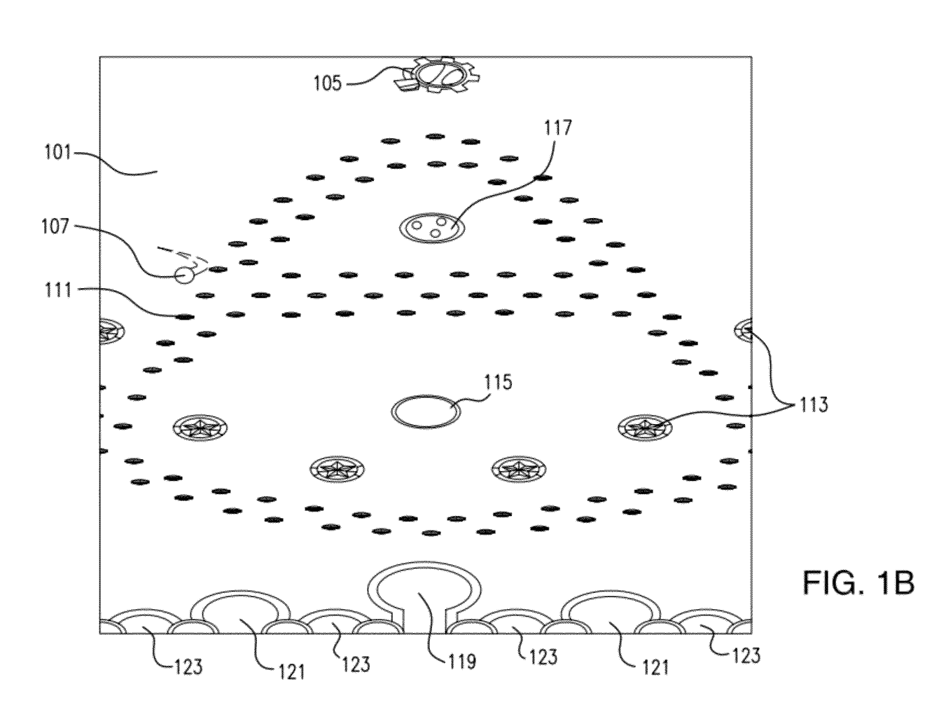

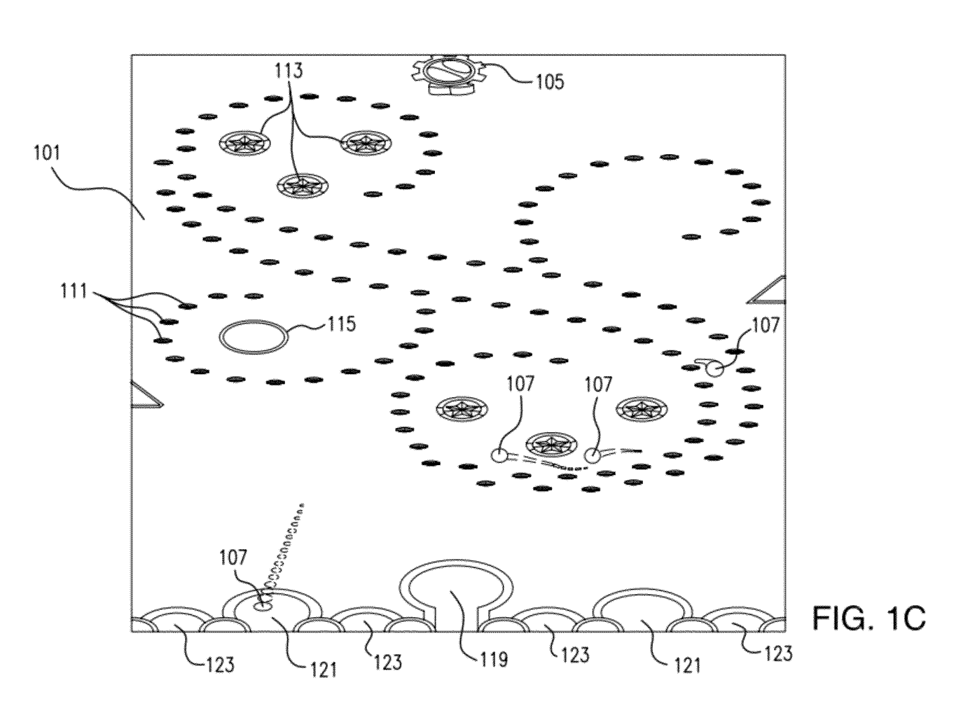

Referring to FIG. 1A, example gaming system 100 is shown with overhead display 101 connected to a bank of networked gaming machines 103 (Egm 1-Egm N). The operative connection between overhead display 101 and the gaming machines 103 allows a community feature game (that is, the graphics for a community feature game) to be presented on the overhead display. As will be described below, the community feature game progresses responsive to one or more respective player inputs made through the respective gaming machines 103. Individual and/or group awards may be provided through gaming machines 103 based on one or more player inputs and corresponding community feature game events in accordance with one or more embodiments.

Overhead display 101 includes launcher 105 which may launch a projectile, such as ball 107. Overhead display 101 also includes a community score display 109 which may accumulate a score achieved by one or more launched balls 107 as they acquire targets along their respective paths. Various targets or obstacles may be shown in the game graphic area of overhead display 101 and may include pins 111 (which may have an associated award, such as 5 credits, for every pin 111 struck by ball 107), bumpers 113 (which may have an associated award, such as 5 credits, for every bumper 113 struck by ball 107). Other obstacles include ball catcher 115 (which when struck by ball 107 may temporarily capture ball 107, launch a mini-game, such as by opening a window with a spinning wheel or mini-set of spinning reels resulting in an outcome, have an associated award, such as 25 credits, based on the mini-game outcome, and then release ball 107), multi-ball launcher 117 (which when struck by ball 107 may cause one or more additional balls 107 to launch and each of balls 107 may strike targets and accumulate awards), and a chute (not shown) (which when entered by ball 107 may launch the ball upward). The illustrated community feature game graphic shown in FIG. 1A also includes buckets (bubbles) 119, 121, 123 (over which balls 107 may roll or pass through) and have respective associated awards, such as 100 credits for bucket 119, 50 credits for bucket 121, and 25 credits for bucket 123.

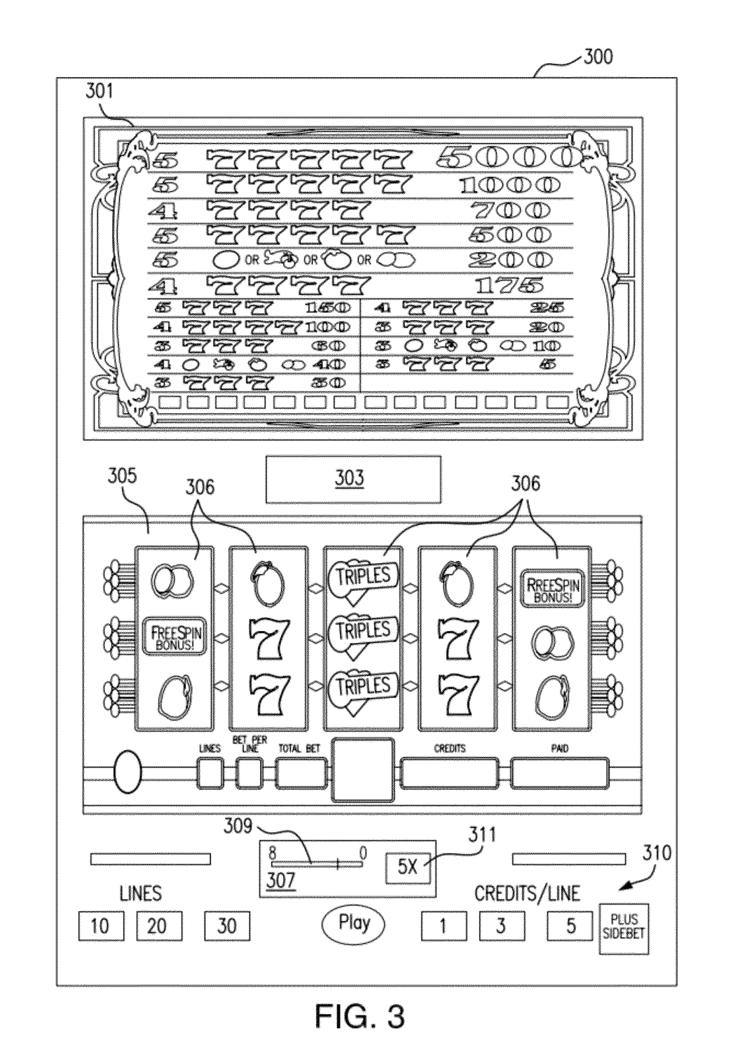

In one or more embodiments, each of the players on the bank of gaming machines 103 may qualify to play the community game based upon one or more criteria, such as by playing the primary game at the gaming machine and achieving one or more milestones, such as a predetermined primary game triggering event, or, an amount of wagers or awards. Each gaming machine 103 on the bank may connect to a master community feature game controller to receive community game status information and transmit player status information, and may include a display (e.g. display 307 of FIG. 3) which may provide player status information and community game status information. For example, display 307 shown in FIG. 3 may show an eligibility timer 309, such as a horizontal countdown bar with a tick indicator (e.g. ticking down a timer to zero) or a vertical bar with a color code indicator (e.g. green, amber, red). These indicators may be initiated following the end of each game play to advise a player of continuing eligibility for the community feature game, and, eligibility may be based on initiating each game play within a pre-specified period (e.g. eight seconds) and playing a pre-specified minimum number of lines (e.g. thirty or maximum lines) with at least one credit wagered per line plus a community game side bet (e.g. twenty credits). Additionally, display 307 may show multiplier meter 311 to indicate the player's achieved multiplier level associated with the community feature game which may be determined as a function of the player's cumulative play and/or credits wagered per line. For example, a player wagering maximum credits (e.g. five credits) per line and meeting any additional wagering requirements (such as wagering on a maximum number of lines plus side bet) may have a minimum multiplier of 5×, and, based on the player's cumulative amount of play, may increase the multiplier to a pre-specified maximum multiplier (e.g. 50×). As another example, a player betting less credits per line, (e.g. one credit per line) may have a minimum multiplier of 1× which may be increased to a pre-specified maximum multiplier (e.g. 10×) based on the player's cumulative amount of play.

In one or more embodiments, the community feature game may be triggered by an event at one or more of the gaming machines 103 shown in FIG. 1A, or by any other event within the network, such as through a processor periodically determining whether to initiate the community feature game. Such a periodic determination may, for example, include use of a random number generator (RNG), a timer, or a counter by a processor to trigger the community feature game. In an example embodiment, a controller (not shown in FIG. 1A) for overhead display 101 may include coding to periodically, such as each tenth of a second, initiate a selection using an RNG and determine whether the selection triggers a community feature game. Alternatively to using the overhead display controller, one of gaming machines 103 may be designated as the community feature game host and perform the controller operation described above to determine triggering the community feature game. In yet another alternative, the community feature game triggering determination may be conducted by a remote server connected to the bank and overhead display through a network (such as depicted in FIG. 3). Once the triggering event occurs and just prior to initiating the community feature game, a signal may be sent by the community feature game controller to each of gaming machines 103. This signal may cause a game processor at each respective gaming machine to: i) store a snapshot of its associated registers indicating the respective player's eligibility and multiplier, and ii) transmit eligibility information to the community feature game controller.

In one or more embodiments, upon the determination to initiate the community feature game, an announcement may be transmitted to each of gaming machines 103 on the bank to advise the players of the impending beginning of the community feature game and possibly to encourage the players to engage in additional play to become eligible or to increase eligibility to play the community feature game. A visual and/or audible countdown may also be presented at each of the gaming machines in the bank, such as through display 307 (FIG. 3) and speakers on each gaming machine 103 and/or overhead display 101 (which may include speakers similar to those currently available with flat screen TVs), to further alert the players of the timing for the community feature game to begin. For example, the community feature game may be triggered and delayed by a period of time, such as fifteen minutes, and players at gaming machines 103 on the community game bank may be advised of the countdown before the beginning of the community feature game so that they may be encouraged to continue to play in order to maintain eligibility for the community feature game or to increase their award potential (e.g. the player's multiplier).

In one or more embodiments, the community feature game may be displayed as a virtual pinball game table or other game surface over which an object may traverse, interacting with various obstacles or features shown on the game surface. During play of the game, each eligible player may have the opportunity to launch a virtual ball, shuttle, projectile, or article (referred to generally herein as a ball, and shown in the drawings by reference number 107) by activating a device such as a button, a track-ball, or joystick on the player's gaming machine console or a virtual button or key on a touch screen. Activating the device may cause a signal to be transmitted to the controller for the overhead display 101 causing the overhead display to show the launch of ball 107. The activating device or some other device at the player's gaming machine 103 may also provide the player the opportunity to select a direction in which ball 107 is to be launched. As the ball proceeds through its course along the display, one or more players may accrue points, credits, and/or awards.

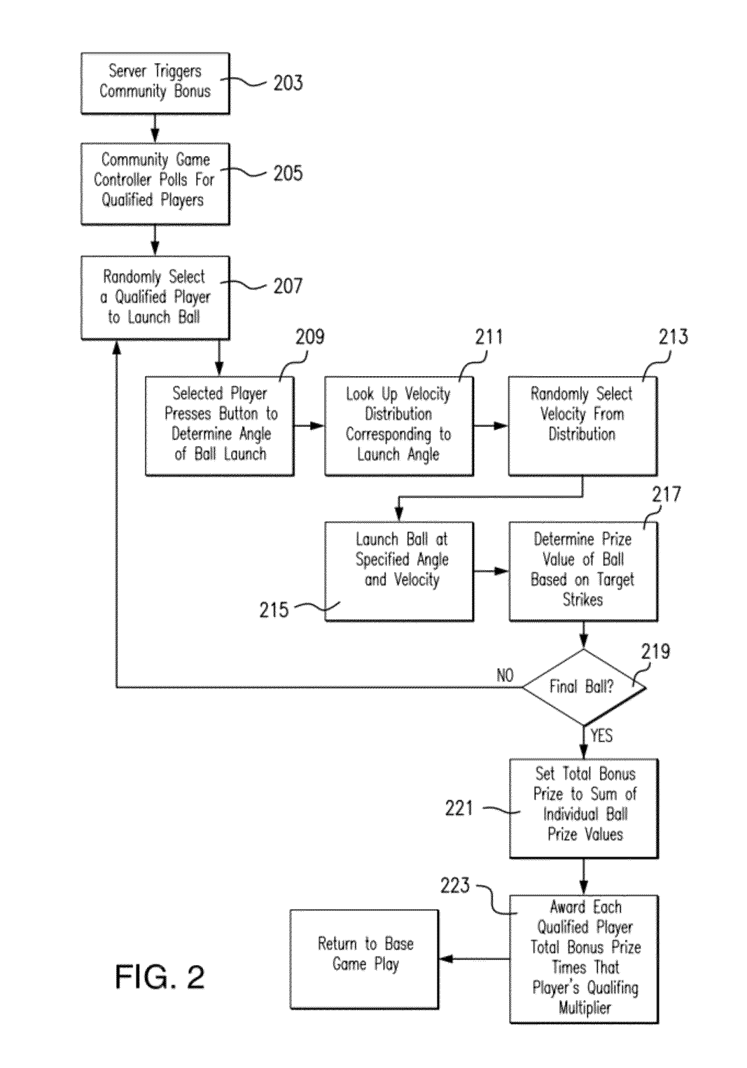

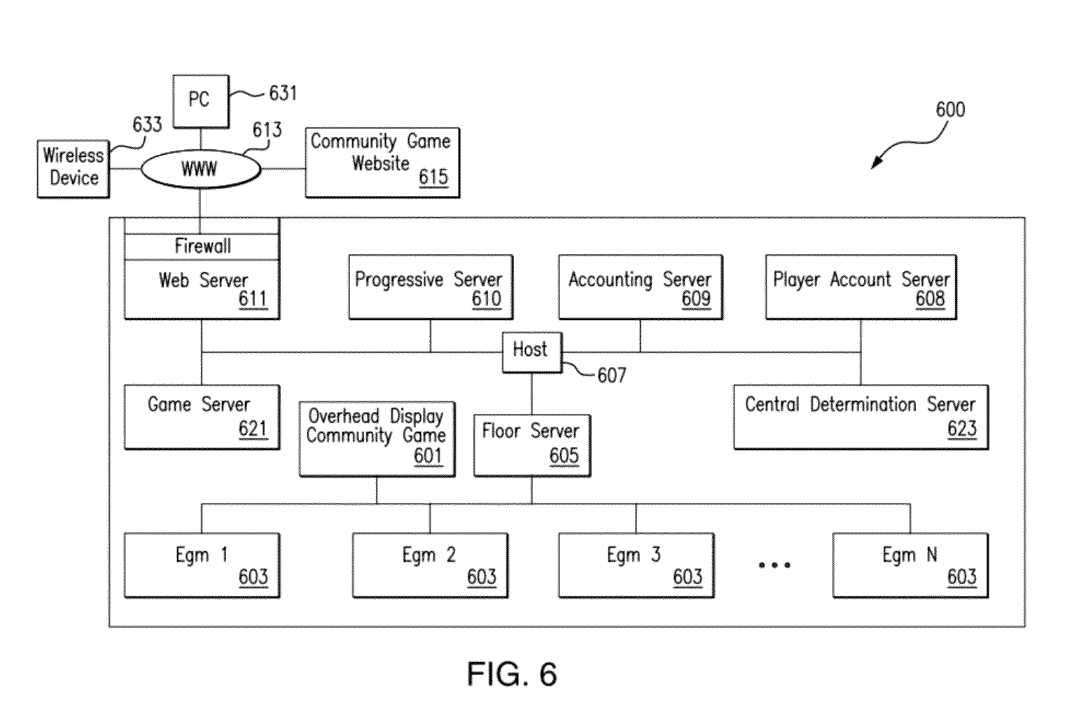

Various processes embodying principles of the present invention may now be described with reference to the flow chart of FIG. 2 and to the gaming system of FIG. 1A and example community feature game displays shown in FIGS. 1A-1C. The community feature game may be triggered as shown at process block 203 in FIG. 2. This triggering step may be performed through a network connected server which may instruct a local community game controller (described below in connection with FIG. 6) to poll the bank of gaming machines 103 to identify qualified players. This polling step is shown at process block 205 in FIG. 2. The local community game controller, or another device in the community gaming system, may then randomly select a qualified player as shown at process block 207 to launch a ball 107. The selected player may watch the launcher 105 on overhead display 101 as the launcher rotates through an arc, and may activate a button (or other user interface device) when the launcher is pointed in a launch direction in which the player would like the ball to travel. This is but one example of an arrangement by which the player may determine or set the angle of the ball launch as according to the step shown at process block 209 in FIG. 2. It should be noted that in the event the selected player does not initiate a launch within a pre-selected amount of time (e.g. five seconds), then the community game controller may initiate the launch and thereby determine the launch direction. Once the angle of launch has been determined as shown at process block 209 or otherwise, the community game controller may, in one embodiment, search a set of tables for a sub-table corresponding to the launch angle, where the sub-table includes a set of potential ball launch velocities, each velocity has an associated award and probability of occurrence. This step of looking up the velocity distribution corresponding the selected launch angle is shown at process block 211 in FIG. 2. The community game controller in this embodiment then randomly selects a velocity from the distribution, such as with an RNG that may use or apply the likelihoods of occurrence in order to determine a velocity as indicated at process block 213. This random selection of a velocity from the sub-table effectively determines the award for the given launch because the starting conditions of launch angle and launch velocity dictates the path through the displayed field of objects according to a physics engine model. The community game controller then causes overhead display 101 to show the launch of the ball 107 at the specified launch angle and velocity as shown at process block 215. The launched ball 107 then traverses the displayed field, striking one or more targets and reacting according to the physics engine model given the specified launch angle and velocity, and achieving the award associated with the specified launch angle and velocity as indicated at process block 217.

If the community game allows for other players to launch one or more balls 107, and if the immediately preceding ball was not the final ball as indicated by the inquiry at decision block 219, the illustrated example process loops back to block 207 to select another qualified player to launch the next ball. The process of selecting a player to launch a ball continues until there are no additional balls to launch. For example, if there are four balls to be launched in the game and four players, then each of the players may have an opportunity to launch a ball; however, if there are only three players and four balls, then one randomly selected player may have the opportunity to launch a second ball.

In one or more embodiments, the awards obtained by each ball 107 may be accumulated as a community award as indicated at process block 221. After all the balls have been played, each qualified player may be paid the accumulated community award as indicated at process block 223, multiplied by the respective player's multiplier level as may be shown on display 307 (as shown in the example gaming machine display of FIG. 3). Setting the total bonus prize value as shown at process block 221, and awarding the prizes to the various players in the community game as shown at process block 223 may be performed under the control of the community game controller described below in connection with FIG. 6.

As indicated at process block 217 in FIG. 2, the prize generated for a given ball launch may be determined at least in part by the manner in which the launched ball interacts with obstacles or features in the displayed game surface, field, or area. For example, there may be a credit award for each small pin 111 (FIGS. 1A-1C) the ball 107 strikes and bounces off, and a larger credit award for bouncing off a larger “bumper” object 113. When the ball strikes “ball-lock” object 115, the overhead display 101 may show the spin of a wheel or a set of reels (neither shown in the community game display illustrations of FIGS. 1A-1C) to determine a prize value to be added to the overall prize for that ball. When ball 107 strikes multi-ball launcher 117, that object may release at randomly generated directions and velocities, several additional balls 107 which then interact with displayed features to generate additional credits to be added for the originally launched ball 107. Ultimately, the ball or balls 107 may strike and be trapped in the various buckets 119, 121, and 123 at the bottom of the displayed playing field area, and a credit value associated with the given bucket may be added to the total for that particular launched ball 107.

Various techniques may be implemented to establish a deterministic spectrum of awards for each ball 107 launched in the example community feature game. In one or more embodiments, various variable features governing the path of the ball may be connected (such as by defining the variables or setting values (e.g. mass, angle of launch, velocity, gravity, targets, obstacles) with a mathematical function incorporating or representing the one or more variable features). For example, the overhead display may have a ball launcher (e.g. launcher 105) positioned (a set value: launch location) at the top of the community game display shown on overhead display 101 from which each identical or substantially identical ball 107 (another set value) may be launched. However, each ball may be launched with a different initial trajectory (a first variable). Two parameters which may be varied to specify the initial trajectory of the ball are angle and velocity. A deterministic physics engine may be used to govern the path of the ball based on the ball's initial trajectory by modifying the speed, so that the initial trajectory (angle and velocity) may specify the path that the ball will take through the field of the display interacting with the various obstacles or features. Thus the corresponding total prize award value (the sum of the individual prize awards associated with each of the objects that the ball meets in its path) associated with each of the balls played in the game may be obtained in accordance with a determined game outcome.

In one or more example embodiments, the initial trajectory of each ball 107 shown in FIGS. 1A-1C may be determined as follows. One of the eligible players on one of the gaming machines 103 may be selected to sequentially launch each of the player's balls 107. A launcher (such as a gun, cannon, catapult, etc.) may be virtually depicted at the launch location on the display, and may move back and forth at a constant angular velocity in real-time over a one hundred eighty degree range of downward-pointing angles (varying from pointing straight left, to pointing straight down, to pointing straight right, and then back). The player may press a launch button to time the release of the ball at a selected launch angle.

Once the player's button press has determined an initial launch angle, the game processor (or community game controller) may access in an associated memory device a table of data generated from the physics engine and identify a sub-table associated with the launch angle, the sub-table comprises a set of velocities (with associated prize and probability values). The game processor may then use a random number generator to select one of the velocities (and thereby determine the prize) from the sub-table, and, initiate launch of the ball at the player selected launch angle and the randomly determined launch velocity in order to achieve the associated prize outcome.

The table of data may be generated with the physics engine by identifying the range of angles, such as from zero degrees through one hundred eighty degrees, and then selecting the number of possible velocities, such as a finite set of static values (e.g. a set of ten velocity values: 450, 460, 470, . . . , 540 millimeters/sec). For each angle, the set of velocities may be associated with a probability of occurrence and an award value. For example:

### Launch Angle of 18.5 Degrees

| Velocity | Award | Probability |
|---|---|---|
| 450 | 1150 | 0.05 |
| 460 | 355 | 0.17 |
| 470 | 1070 | 0.05 |
| 480 | 390 | 0 |
| 490 | 310 | 0 |
| 500 | 360 | 0.29 |
| 510 | 285 | 0.24 |
| 520 | 175 | 0 |
| 530 | 605 | 0.15 |
| 540 | 1300 | 0.05 |

With reference to the example sub-table, the probability of one of the velocities occurring may be seen as one, while the expected prize value may be 499.9 (sum of the products of the associated award and probability at each velocity). For each of the other sub-tables of respective launch angles in the table, each associated sub-table may have its own probability distribution and prize values; however, the sum of the probabilities should be the same in each sub-table. Also, the expected prize value should be the same for each sub-table, if it is desired to have a random and non-skill based game and outcome. In cases where a percentage of an award may be determined by skill, such as by five or ten percent, then the expected prize values and/or probabilities in individual sub-tables may be varied to reflect the percent of allowed variability (for example in such cases, a player may select an optimum or better launch angle to improve the potential award).

It should be noted from the above example sub-table that the spectrum of awards available for a given player-selected variable, launch angle in this case, need not be an even distribution across the available values for the randomly selected variable or variables. Some of the values for the randomly selected variable in the example table are even associated with a zero probability.

In order to construct the velocity probability distributions for each angle according to one example, the physics engine may be programmed with each result (including the sequence of bounces and corresponding prize) associated with each angle-velocity combination. In the event that there are undesirable combinations (e.g. trajectories that result in the ball getting stuck somewhere on the board, or trajectories that have fewer than some minimum number of object-collisions), it may be desirable to discard certain angle-velocity combinations. Once the discarded combinations are determined (throwaways), then the velocity/award probability distribution for each sub-table associated with a respective angle may be generated such that every angle has the same expected prize value (EV, e.g. 499.9) (sum of the award*probability of each velocity) associated with its corresponding sub-table. This may be accomplished by (after throwaways) identifying each sub-table that results in a lower-than-EV prize value or a higher-than-EV prize value, and then weighting each set of sub-table outcomes to obtain the desired EV.

The community feature game process shown generally in FIG. 2 is subject to a wide array of variations within the scope of the present invention. Alternative embodiments of the community game may provide both a community award paid or apportioned to each player plus an individual award. For example, each player may play at least one ball that accumulates an individual award for that player. There may be one or more additional community game balls that are launched to accumulate a community award that may be paid to each player, divided equally amongst the players, or apportioned according to some relative factor of the players, such as by using the multiplier level of the respective players. Additionally or alternatively, the awards attributed or distributed to each player from the community game may be multiplied by the multiplier level.

In one or more alternative embodiments of the community game, individual and/or community awards may be associated with at least one ball played by each player. For example, the sub-table associated with each launch angle may include both individual and community awards corresponding to each velocity whereby a player and the community of players may accumulate potentially different award values based on the path of each ball.

In some embodiments, each player may be identified by an indicator (such as gaming machine one, two, three, etc., or, red, white, blue, gold, etc.) which may be displayed along with the accrued individual award for that player on or about display 101, such as player score display 131. In embodiments where the player award is simply a multiple of the community award, player score display 131 may display the associated multiple, whereas in cases where players may obtain individual scores which are not simply multiples of the community score, the score displayed in player score display 131 may be the player's respective individual score and the applicable multiplier or the individual score to which the applicable multiplier has already been applied. Any community awards may be an amount that may be apportioned to respective players based on some factor (such as the players' multipliers) or multiplied with the respective player's multiplier level and then added to the respective players' credit meter as accrued (or at the end of the community game), in addition to the player awards, if applicable. With respect to player indicators, a player may be able to select an indicator, such as blue, if available. Another indicator that may be applied may be the player's name or initials which may be obtained from an inserted player card. Other types of indicators may be used as well, such as avatars.

In one or more embodiments, the content displayed on display 101 of FIG. 1A-1C may also be displayed on a participating player's gaming machine display (such as display 305 or 301 as will be described below in connection with FIG. 3). Once the community game has concluded, the community game content may be removed and the player's primary game may be re-displayed, returned, or made visible (such as in the case where an overlaying screen content of the community game has covered or blocked the visibility of an underlying screen displaying the primary game).

In another example alternative embodiment, the community game may provide an opportunity for each player to initiate launch of a respective ball 107, however the launch vector and velocity may both be randomly determined, either collectively or separately.

In one or more embodiments, the community game as described above may be implemented with progressive as opposed to fixed awards wherein each of the sub-tables may be modified to associate each launch velocity with an award factor. For example, the above-identified sub-table associated with launch angle 18.5 degrees may be modified as follows:

### Launch Angle of 18.5 Degrees

| Velocity | Award | Probability |
|---|---|---|
| 450 | 1150/1300 | 0.05 |
| 460 | 355/1300 | 0.17 |
| 470 | 1070/1300 | 0.05 |
| 480 | 390/1300 | 0 |
| 490 | 310/1300 | 0 |
| 500 | 360/1300 | 0.29 |
| 510 | 285/1300 | 0.24 |
| 520 | 175/1300 | 0 |
| 530 | 605/1300 | 0.15 |
| 540 | 1300/1300 | 0.05 |

In this example, the award associated with a given velocity may be multiplied by a base amount in a progressive pool. The progressive pool may be generated in various ways including an initial seed value applied by the casino operator, plus an accumulation of any required side bets during a selected period associated with the community feature game, or, a percentage of the total wagers or hold amount during a selected period from the respective gaming machines in a bank associated with the community feature game, or a combination thereof. The selected period, for example, may be the period between a previous and a current play of the community feature game. The base amount in the progressive pool may be defined algorithmically, such as by using probability tables based on the number of opportunities (for example, ball launches) in a given play of the community game, by dividing the number of opportunities into the total amount in the progressive pool or a percentage thereof, or by simply using the total amount in the progressive pool. In the latter case, the casino operator may need to replenish the pool during play of the community feature game if the total amount in the progressive pool is expended. A percentage, which may be the entire amount, of any remainder in the progressive pool following play of the community feature game may be rolled-over to a subsequent community feature game pool. In the event that a fixed award is implemented as provided in the initially described sub-table, then a threshold requirement may be implemented with respect to the community feature game so that the community feature game may not trigger until a threshold of wagers, hold, or side bets have occurred.

In one or more embodiments, the player selectable or determinable variable may be launch velocity as opposed to launch angle. In such a case, a sub-table for each velocity over a range of selectable velocities may be generated in which each sub-table includes a range of potential launch angles (for example, zero to one hundred eighty degrees), each angle with an associated probability of occurrence (which may be zero) and award, and the feature game controller may use an RNG to determine the launch angle.

In one or more embodiments, the active element of the community feature game may comprise a wide variety of objects associable with a field, space, or surface (game surface) to achieve a predictable outcome by ascertaining a value for each of the variables required to model the association of the object with the game surface. For example, in the case specifically described herein, the active element comprises a ball or defined object launched onto a surface or course and awards are acquired based on the path traversed which is predictable by generating a mathematical model, fixing or specifically defining each of the elements of the game surface, and defining the launch angle and velocity of a ball of known mass, circumference, gravity, and having known collision properties. Another example active element may include a rocket or projectile launched from a defined location at a selected launch angle and velocity where the path may be into space with a variety of celestial objects, obstacles, and/or targets which may garner awards for the player based on performance of the rocket. In another example, a rocket may be launched from one location to reach another location whereby the player may gain an award based on the proximity of the launched rocket to the target location at impact. Other objects that may be modeled on various fields include cars, planes, and boats in which cases a trajectory may be determined based on a launch velocity and direction similar to the community game described herein.

The community feature game described above in connection with FIGS. 1A-1C provides but one example of a game in which the game outcomes may be defined by a function of at least one player selectable variable and at least one variable that is randomly or pseudo-randomly determined. More generically, the present invention applies to any feature game in which the feature game outcomes are defined by a function f(x,y), where the player may select a value for “x” within a range of possible values, and the value for “y” is randomly or pseudo-randomly determined. In one or more embodiments, for each possible value for “x,” a sub-table (set) may be generated of possible “y” values, each possible “y” value having an associated probability of occurrence and an associated award. The present invention also applies where the game outcomes are defined as a function of more than two independent variables f(x,y,z, . . . ). In these forms of the invention, the player may be provided an opportunity to select a value for one or more variables but not all of them, and the remaining un-selected one or more variables may be determined randomly or pseudo-randomly, such as from a sub-table generated with the player-selected values for the selected variables where the sub-table includes a set of possible values for the unselected variables along with an associated probability of occurrence and award for each possible combination of values. As shown above in the example tables, the range of values may be limited to a range or fixed and various undesirable value combinations may be eliminated.

FIG. 3 illustrates an example display arrangement 300 on the front of a gaming machine, such as one of the gaming machines 103 shown in FIG. 1A, through which a qualified player may launch a virtual object or projectile shown on an overhead display (101 in FIGS. 1A-1C) to accumulate community feature game awards in accordance with one or more embodiments. This example display arrangement 300 shown in FIG. 3 includes a top glass display 301, middle display 303, primary display 305, and lower display 307. FIG. 3 also shows a user interface 310 of gaming machine 103 in accordance with one or more embodiments of the invention. This example display arrangement 300 includes a set of video or mechanical reels 306 in primary display 305 which are spun to present a random or pseudo-random primary game outcome in response to a play of the primary game entered by a player at the gaming machine. Typically, the player initiates a play in the primary game by placing a wager and then activating a “Play” button for the primary game. Awards for primary game outcomes are paid in accordance with a paytable. It will be appreciated that games other than a primary game and the community feature game described herein may be offered through a gaming machine having a display arrangement such as 300 shown in FIG. 3. For example, the primary game may be associated with one or more secondary or bonus games displayed through the various display devices in display arrangement 300.

Top glass display 301 may comprise a portion of a larger display device, or a separate display (such as an LCD, LED, TFT, etc. display), or a static display. In any case, top glass display 301 presents information related to the primary game or theme, such as a display of the paytable associated with the primary game and indicating the awards payable on the various winning primary game outcomes. Display 303 (which may be an LCD, LED, TFT, etc. display) may be used to display alternative games (such as a bingo, lottery or other wagering game) or other feeds (such as advertisements) presented through a gaming network in which the gaming machine may be included. Any alternate or additional games offered through display 303 may or may not require separate wagers or consideration, such as player points accumulated in a player account by a player. Primary display 305 may display a primary game, such as the displayed “Triples” reel-type game, and further display additional information such as lines wagered upon (“Lines”), bet per line (“Bet per Line”), total bet (“Total Bet”), credits on the gaming machine (“Credits”), and any winnings paid following a game play (which may include primary, feature, and community game play) (“Paid”). It will be appreciated that primary display 305 may either comprise a display device such as an LCD, LED, TFT display, to display a video representation of reels 306, or may include mechanical elements such as mechanical reels. Display 307 may comprise a portion of a larger display, or may comprise a separate display (such as an LCD, LED, TFT, etc. display) and display eligibility timer 309 and multiplier meter 311. As described above, timer 309 and multiplier meter 311 indicate the player's status with respect to a community feature game, such as the player's eligibility to participate in the community feature game and the player's achieved multiplier which may be used to multiply any award obtained by the player from the community feature game. User interface 310 represents part of a user interface system and generally includes a button deck for entering the selected number of lines the player wishes to wager upon, the number of credits per line plus a side bet, and to initiate play of the primary game. User interface 310 may also include a card receiver for receiving a player card and transmitting player information over a network, and, may include a bill acceptor for receiving currency including tickets and a printer for printing tickets when a player desires to cash out from the gaming machine.

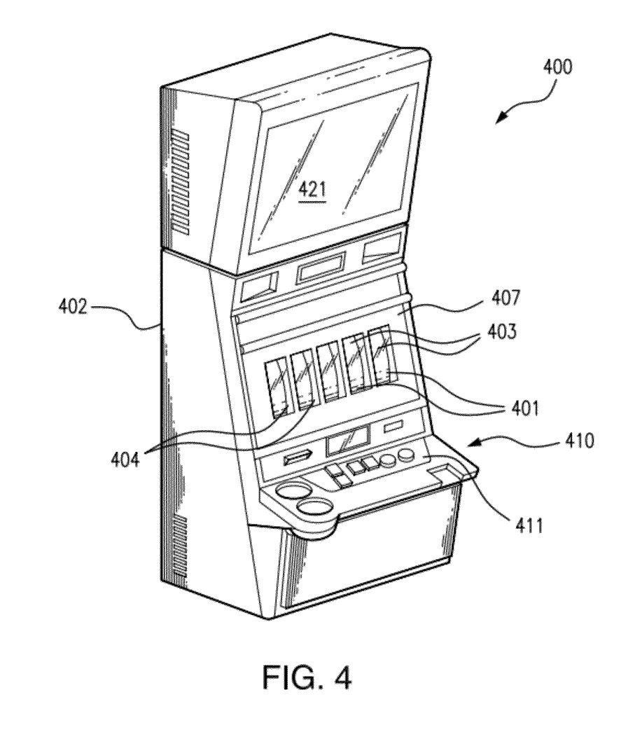

Referring to FIG. 4, gaming machine 400, such as a Multimedia Games M11m_Triples_{—}30L150C gaming machine, may be employed as one or more of the gaming machines 103 shown in FIG. 1A. Gaming machine 400 has a set of mechanical reels 401 in reel display area 407 with display windows 403 oriented to enable viewing portions of reels 401. Gaming machine 400 also includes a player interface 410 including button deck 411. Gaming machine 400 may be controlled by a game processor with associated memory for primary and feature game program code and community feature game program code executable by the game processor. The game processor, associated memory, and associated printed circuit boards are housed in or about gaming machine cabinet 402 along with ports connecting to various sub-assemblies. While gaming machine 400 is shown as an upright gaming machine cabinet style, various cabinet styles may be utilized including a slant top cabinet style and a bar top cabinet style (where the cabinet may be part of a bar/table top and/or housed therein).

Each reel 401 includes a series of symbols (as shown by example in FIG. 3) viewable on or through display panel or windows 403. With the reels 401 in a stationary position, the symbols visible through windows 403 may be viewed as an array of symbols (for example, a 5×3 array of symbols as shown in the example of FIG. 3). During a primary wagering game, such as may be initiated by a player, the reels 401 may be spun about an axle or simulated to spin under the control of a game processor which may randomly or pseudo-randomly determine the game outcome and cause the reels to stop in accordance with the determined game outcome, or may use any suitable technique to cause the reels to stop to display an outcome.

One or more paylines, combinations, or patterns of the symbols including those visible in reel display area 407 may be correlated to a game result payable such as the paytable shown on display 301 in FIG. 3. Reel display area 407 may thereby be used to display the game result to one or more patrons standing in front of gaming machine 400. While example gaming machine 400 includes a set of five reels 401, various numbers of reels may be selected or utilized in an implementation of one or more embodiments, such as one, two, three, four, five, six, seven reels, and so forth. Display windows 403 may comprise an area of reel display area 407 or may comprise a separate layer. Panel dividers or frames may be painted, etched, etc. onto reel display area 407 to provide a separate viewable area or window 403 for each reel 401. The windows 403 serve to focus attention to the visible portion of the reels 401 and to overlay reel dividers 404 and the space between reels 401.

Alternatively to painting, etching, or otherwise forming windows 403 onto reel display area 407, reel display area 407 may comprise a display panel, such as a flat panel LCD or LED display, which may be programmed to display an opaque frame image except over the display area of reels 401 which may be transparent or translucent during game play of the primary wagering game. In such case, display surface area 407 may be programmed to display a bonus or feature game that may be triggered as discussed above by the appearance of one or more special symbols, and, a touch sensitive panel (such as an overlay of reel display area 407) may be implemented to enable player interactivity, such as to select a displayed button or item, in order to cause the game to perform additional steps and provide one or more bonus or feature game outcomes and awards to the player.

Additionally, while gaming machine 400 is described using mechanical reels with fixed symbols, reels 401 may be implemented using FOLED (flexible organic LED) reel strips wherein one or more symbols may be programmed dynamically to vary the symbol and/or its appearance. Additionally, one or more display panels may be implemented to present each reel 401 virtually, that is, via a video animation. In the case of virtual displays of the reels, the symbols may be fixed or animated on each of reels 401. Also, overlapping display panels may be implemented to generate video or display effects over mechanical reels 401. For example, display windows 403 may be implemented as a light-transmissive or transparent display configured to display visual effects together with reels 401 under the control of the game processor during the operation of a wagering game. In the case of virtual reels, the virtual reels may be recessed a distance from the front surface of reel display area 407 and segregated by dividers similar to dividers separating mechanical reels, which may provide a spatial characteristic for the video-generated reels.

In one or more embodiments, the game processor operating the wagering game and controlling game lighting and effects in many instances is implemented as a microprocessor on a printed circuit board including one or more memory devices positioned within gaming machine 400. In alternative implementations, the game processor may be remote from gaming machine 400, such as on a server network connected to gaming machine 400 (e.g. network 600, FIG. 6). In the case where the game processor for gaming machine 400 is remote from the gaming machine, game operation as described herein may be accomplished through network communications to control the display of the game on gaming machine 400 including the audio, visual and game effects. It should be noted here that any terms indicating relative position used in this disclosure and the accompanying claims such as “front,” “rear,” “lateral,” “back,” and “top,” for example, are used with reference to the operating position of gaming machine 400 shown in FIG. 4.

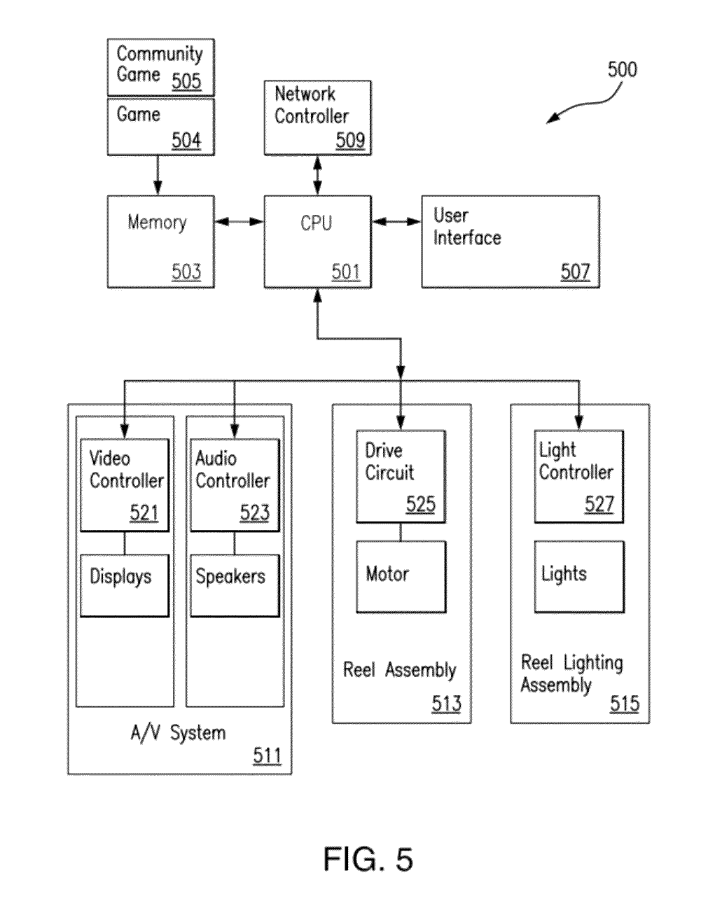

Referring to FIG. 5, an example control structure 500 of gaming machine 400 is shown in accordance with one or more embodiments of the present invention. Game processor (CPU) 501 may comprise a conventional microprocessor, such as an Intel® Pentium® or Core® microprocessor, mounted on a printed circuit board with supporting ports, drivers, memory, and coding to control gaming machine operations, such as through the execution of coding (program code) stored in memory 503 including one or more wagering games 504 and community game 505. Game processor 501 connects to user interface (a user interface system) 507 such that a player may enter input information and game processor 501 may respond according to its programming, such as to apply a wager and initiate a play of a game. Game processor 501 also may connect to a network, such as casino server network 600 (FIG. 6), through network controller 509 to enable network monitoring and sharing of data and information between the respective servers in the network and gaming machine 400. Game processor 501 may also connect to various devices within and about the gaming machine including A/V system 511, reel assembly 513, and reel lighting assembly 515 through respective controllers, such as one or more video controllers 521, audio controllers 523, motor drive circuit controller 525, and light controller 527. In the case where the reels are implemented using a video display, reel assembly 513 and reel lighting assembly 515 may be modified or eliminated depending upon the desired configuration. For example, in one or more embodiments, it may be desirable to use reel lighting assembly 515 to amplify or provide various light effects in conjunction with a video reel display during game play, alternatively this functionality may be absorbed into the video display coding and presentation.

Generally, activity at gaming machine 400 (and gaming machine 103 in FIG. 1A) may be initiated by a player inserting currency and/or a player card into a bill acceptor and card reader, respectively. Upon insertion, a signal is sent to game processor 501. In the case of the insertion of a player card, the card reader transmits card information which is directed through network controller 509 to a player tracking server connected to the network. Player data is transmitted to gaming machine control structure 500, and responsive to the data, game processor 501 may execute coding causing player data and a display (and possibly an audio) command to be transmitted to one of the video and/or audio controllers instructing the controllers to cause the player information to be displayed on a respective display and possibly to cause an audio greeting to be generated through one or more respective speakers. Concurrently, the bill acceptor sends a signal to game processor 501 which may include an identification of the currency that has been read, and game processor 501 in accordance with its coding may convert the currency amount to credits and transmit a store and display signal to a credit meter and its associated display (for example the “Credits” display window in FIG. 3). Once credits have been associated with the credit meter, the player may select the number of paylines and credits per line that the player wishes to wager, whereupon game processor 501, in accordance with its coding, receives the wager information from user interface 507, transmits accounting and display information to the payline (“Lines”, FIG. 3), credits per payline (“Bet per Line”, FIG. 3), and total bet (“Total Bet”, FIG. 3) meters and displays, transmits an update to the credit meter and display (“Credits”, FIG. 3) deducting the amount of the total bet, and initiates a play in the wagering game.

In the case of Class III gaming devices, when a game is initiated, a random number generator (RNG) may be operated by game processor 501 to determine the game outcome. Commonly, game processor 501 is positioned within gaming machine 400 (FIG. 4) and configured to manage the operation of the gaming machine components, such as shown in FIG. 5; however, the game processor may be either onboard or external to a gaming device such as an electronic tablet computer (e.g. Apple® iPad® or gaming specific tablet), personal data assistant (PDA), cellular telephone (e.g. a smartphone), surface table (e.g. Microsoft®/IGT® touch sensitive gaming surface table) played by a player. Therefore, when the player places a wager and initiates play of the game through user interface 507 of the gaming device, the game processor may be onboard or remotely located such as within a network gaming server. In the latter case, an onboard microprocessor, controller, or digital signal processor of the gaming device or machine may execute coding to transmit the wager and game request information through the network and the remote game processor may operate an RNG to determine the game outcome. In one or more embodiments, coding may be stored in memory 503, and may be executable by game processor 501 to control the primary and feature game execution and to control associated electro-mechanical devices, such as reel lighting, speakers, and reels through respective video, audio, reel drive motor controllers, and lighting controllers 521, 523, 525, 527.

In addition, coding may be stored to execute and/or integrate gaming device operation with a community feature game, such as described herein, where gaming machine 400 may be designated as the community feature game controller or one of the client gaming machines 103 on the bank illustrated in FIG. 1A. For example, each gaming machine 103 (such as gaming machine 400, FIG. 4) of a bank may include coding executable by the respective game processor to initiate and operate the community game and also coding to respond as a client gaming machine on the bank responsive to a primary game controller. One of the gaming machines 103 may be designated as the primary community game controller responsible for operating the community game and overhead display 101 shown in FIG. 1C. In the case that the primary community game controller becomes unavailable, a second gaming machine 103 may be designated as the backup primary community game controller and a rule of succession may be coded into each of gaming machines 103 of a respective bank. Each of the gaming machines 103 may include monitoring coding executable on an ongoing periodic basis to ascertain which gaming device is the active primary community game controller during a given time period. Alternatively, the primary community game controller may be responsible to execute periodic polling of each of gaming machines 103 of the respective bank. In the event that the backup primary community game controller does not receive a poll within a designated period, the backup primary community game controller may commence operation as primary community game controller, commence polling operations, and commence execution of coding to randomly determine when to initiate the associated community game.

In one or more alternate embodiments, gaming machine 400 may operate a primary game and a feature game as stand-alone games, wherein the feature game may be operable substantially as described herein except that both the primary game and feature games are operated without participation by other players. For example, the feature game may be triggered by the same or similar types of mechanisms as described with respect to the community feature game (such as through an RNG operable by game processor 501 or by use of a threshold based on the accumulated amount of side bets or wagers on respective gaming machine 400, or any combination thereof, or, by the appearance of a predetermined number of special symbols on or off an active payline).

Once triggered, the feature game may be displayed on one of the displays operable by gaming machine 400, such as display 421 or reel display area 407 (where this area includes a video display) or even one of the smaller displays where a video representation of the feature game may be presented by either replacing or overlaying primary game display content for that display. For example, if reel display area 407 includes mechanical reels 401, reel display area 407 may include an overlaying video display (such as a flat panel display) which may be changed from a transparent mode to a feature game display mode by game processor 501 to mask the mechanical reel display window. In the case where reel display area 407 comprises two or more displays with or without mechanical reels, one or both displays may be used separately or together to display video content for the primary game and the feature game (for example, special effects or symbols may be rendered through an overlaying display while the underlying display displays the reels of the primary game or the field (or surface) of the feature game, depending upon which game is being shown or played).

In the stand-alone feature game, as in the community feature game, the player may be provided one or more balls (such as balls 107 in FIGS. 1A-1C) to launch. For example, the number of balls may be predetermined (such as four balls) for each instance of the feature game, or there may be a predetermined range of the number of balls and the number of balls for a particular feature game may be determined with an RNG by game processor 501, or, there may be a minimum number of balls (such as two balls) for a lowest level which may be increased depending upon an achieved playing level at the time that the feature game is triggered.

As with the community feature game, various multiplier levels may be achieved as the result of primary game play of the player. For example, a player playing one credit per line may achieve an initial multiplier level of one, while a five credit per line player may achieve an initial multiplier level of five. Depending upon the speed of play or amount of wagers over predetermined periods, such as each minute, the multiplier level of respective players may increase and be shown on multiplier level display 311. Additionally, to be eligible for the feature game, the player may be required to wager on a minimum number of lines and may or may not also be required to wager a side bet. Once a player has played the minimum required for eligibility for the feature game, the player may participate in the next feature game if the feature game is triggered by the primary game play (such as by the appearance of special symbols) or triggered by an alternate trigger mechanism (such as through a random selection performed periodically, for example every second by game processor 501 using an RNG) within a predetermined period (such as eight seconds) following the end of a prior qualified play. For a player to maintain continuous eligibility for the feature game in this eligibility scheme, the player must initiate each successive play of the primary game within the predetermined period following the completion of the prior game play. A countdown of the eligibility time after a given play of the primary game may be presented in a graphic display for the player such as through the timeline 309 on display 307 in FIG. 3.

Referring to FIG. 6, a block diagram of example gaming network 600 associated with one or more gaming facilities is shown including community game overhead display 601 operably connected to a designated bank of gaming machines 603, such as a bank of four gaming machines 603, to provide a community feature game (as described herein) in accordance with one or more embodiments.

As shown in FIG. 6, a selected bank of gaming machines 603 (Egm 1-Egm N) and overhead display 601 may be network connected through Floor Server 605 to Host Server 607 which in turn connects to various back-end servers, such as player account server 608, accounting server 609, progressive server 610, web server 611, game server 621, and central determination server 623 (the latter being used in the case of some Class II gaming operations).

In one or more embodiments, game server 621 may provide server-based games and/or game services to network connected gaming devices, such as gaming machines 603 (which may be connected by network cable or wirelessly). Progressive server 610 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server. Progressive awards may be implemented so as to provide a large potential award to players playing the community feature game. Accounting server 609 may receive gaming data from each of the networked gaming devices and perform audit functions. Player account server 608 may maintain player account records and persistent data such as accumulated player points. With reference to FIG. 6, while a few servers have been shown separately, they may be combined or split into additional servers having additional capabilities.

In one or more embodiments, gaming network 600 may include web server 611 connected to a public web network, such as worldwide web (WWW) network 613. Community Game Website 615 may externally connect through network 613 to web server 611 through a firewall in order to provide access by gaming network 600 to player information, such as a player's community game or associated points obtained from non-wagering gaming activity. Such a service, for example, may be offered to a casino operator on a fee basis or through a subscription service with the community game website provider, whereby a casino operator may access a player's records, view a player's activity at community game website 615, and choose, based on the player's activity, to offer or provide promotional credits or incentives to the player at the casino operator's facilities.

Community gaming website 615 may offer players a variety of games to play including the community feature game as substantially disclosed herein. A player may have an opportunity to sign-up to establish an account and be provided free playing credits of no remunerative value. By playing one or more of the games, the player may accumulate player points to establish a playing record which may later be accessed by a subscribing casino operator as described above. In one or more embodiments, the accumulated player points may have a remunerative value, such as for obtaining rewards. An example reward may be an all expenses paid trip to a particular resort and casino. Another example may be promotional credits for use at a designated gaming facility. Each of these rewards may be sponsored by the respective casino operator, or the community game website provider may offer such rewards as part of its player incentive program.

In one or more embodiments, a casino operator may be able to program player rewards through a user console (not shown, similar to a cash/ticket voucher kiosk or ATM) connected to host server 607 whereby a player may enter the player's community game website account information onto the user console and request promotional credits or some other award made available by the casino operator. In such case, such rewards may automatically be applied to a player's account associated with the casino operator or may be obtained at a player window located at the operator's facility.

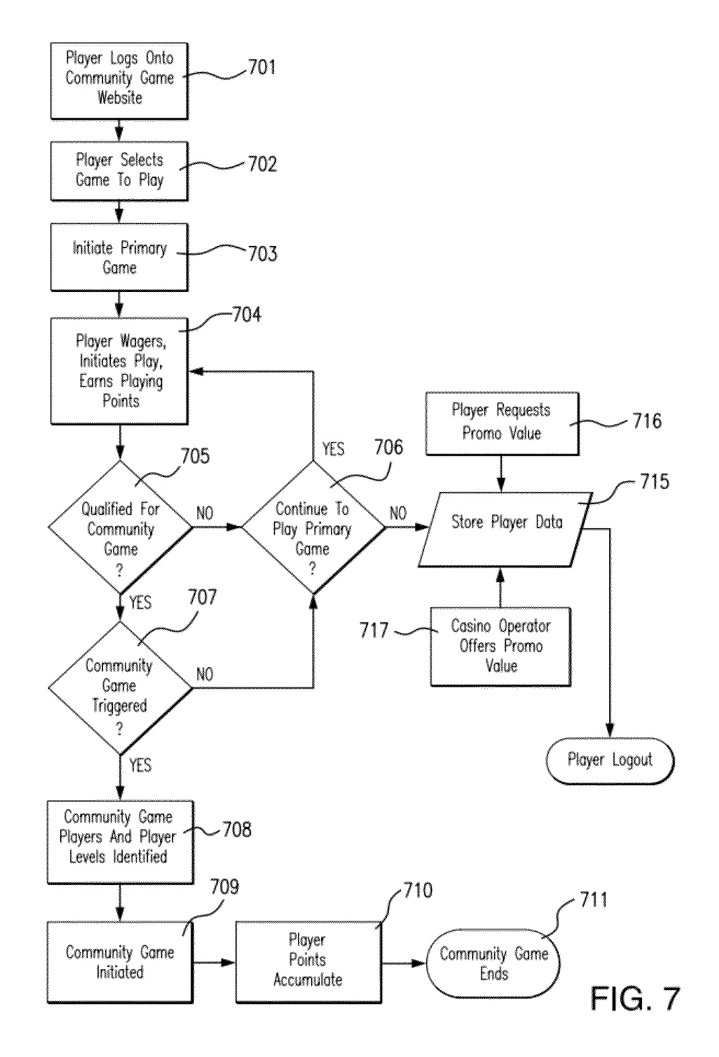

FIG. 7 shows an example flowchart of web-based community game process 700 which may be employed through the network 600 shown in FIG. 6. In the following description it will be appreciated that references to process steps are references to the various process blocks shown in FIG. 7, while references to physical devices and systems will be references to the devices and systems shown in FIG. 6.

A player may log into community game website 615 through personal computer (PC) 631 or web-enabled wireless device 633 (such as an Apple® iPhone® or iPad®). This login step is shown at process block 701 in FIG. 7. Once logged on, the player may select to play a game as shown at process block 702. In response to this selection, community game website 615 initiates the requested primary game for the player and adds playing credits for the play of the game as shown at process block 703. These credits may be in the form of points or virtual dollars to play the primary game. The player may then use the provided credits to make wagers in the primary game and accumulates additional credits or points as shown at process block 704. These credits or points may qualify the player for a web-based occurrence of the community feature game. If the player is not qualified for the community feature game as indicated by a negative result at decision block 705, and if the player desires to continue play of the primary game as indicated by a positive outcome at decision block 706, the process loops back for further play of the primary game according to process block 704. If the player is qualified for play of the web-based community feature game as indicated by a positive outcome at decision block 705, and if an instance of the community feature game has been triggered, the process continues with the conduct of the community feature game. Otherwise, if the player is qualified for the instance of the web-based community feature game but the game is not triggered, the player may continue play of the web-based primary game to accumulate additional points to increase player level, such as to earn additional community feature game player or launch opportunities, or, to increase a multiplier level from one and higher (which may be used to multiply a community feature game award).

As shown at process block 708 in FIG. 7, the conduct of the web-based community feature game includes polling for player activity to identify qualified players for the community feature game, and to identify the player level for the play of the game. The illustrated example process then includes initiating the web-based community feature game as shown at process block 709, displaying the game field (such as the example game field shown in FIGS. 1A-1C) on each participating player's display, and providing a user interface as necessary (such as virtual buttons on a touchscreen of the device through which the player is playing). Each qualified player may take the actions in the community feature game as described above for the casino-implemented community feature game. However, rather than accumulating wagering credits as in the casino implementation, the players of the web-based community feature game accumulate points as shown at process block 710 for further play of the primary game or future instances of the web-based community feature game. When the web-based community feature game ends as shown at process block 711, the player may opt for continuing play of the primary game to accumulate additional points, may log out of gaming website 615, or may make a request for conversion of points to awards, prizes, or promotional credits. For example, the player may redeem their web-based game points for promotional credits applied to their casino player account.

It will be noted that website 615 collects player information including accumulated points from both the web-based primary game and web-based community feature game, and causes this information to be stored at appropriate locations in the network shown in FIG. 6. as shown at process block 715 in FIG. 7 (at storage associated with web server 611 for example). This information collected through website 615 may be accessed by the networked casino site when the player identifies themself at an appropriate manned or automated player interface included at the casino site. Promotional credits for the player's web-based playing points may then be applied to the player's casino player account as indicated at process block 716 in FIG. 7. Also, in some implementations, the casino operator may access the website-collected information without the player's knowledge in order offer the player various types of promotional value based on the stored information. The access to the stored information by the casino operator is shown at process block 717 in FIG. 7.

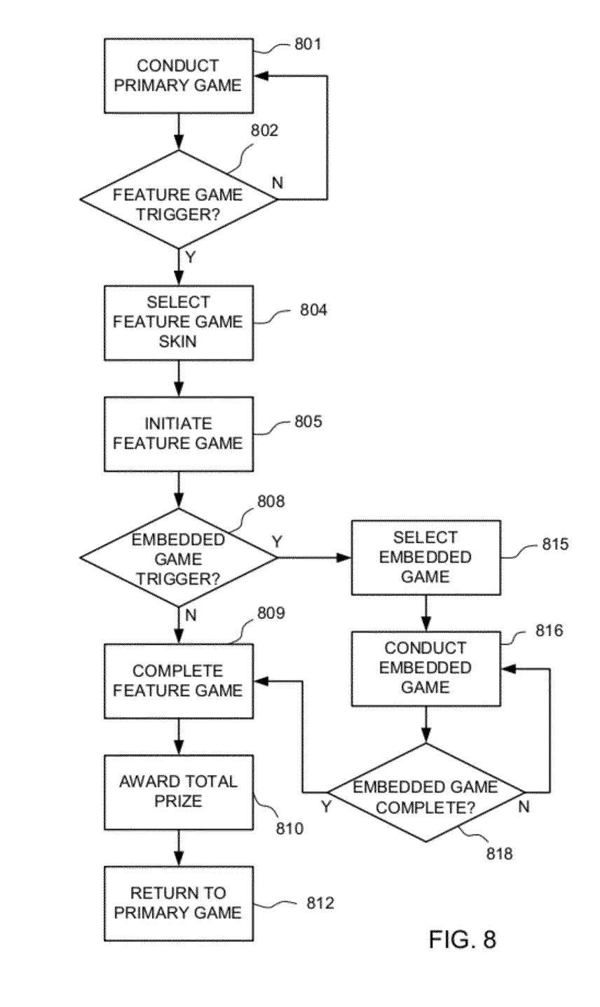

FIG. 8 illustrates a process that may be conducted with a feature game as described above or a different feature game in either a standalone or community game context. In this process, a separate bonus game is embedded in the feature game and is conducted in response to a trigger in the feature game.

As shown in process block 801 in FIG. 8, the process includes conducting a primary game which may be any type of wagering game which may be conducted through a gaming machine. In response to a feature game trigger as indicated by an affirmative outcome at decision box 802, the method includes selecting a feature game skin as indicated by process block 804. This step of selecting a feature game skin may be performed randomly or in any suitable fashion to select from between two or more skins or alternate graphic presentations for the feature game. Although some forms of the invention include different feature game skins which are identical in operation, there may also be operational differences between the different skins from which the selection is made at process block 804.

After selecting a skin for the feature game, the process includes initiating the feature game as indicated at process block 805 in FIG. 8. If at any time during the course of the feature game, an embedded game trigger occurs, the process branches from the feature game process as indicated by the affirmative outcome from decision box 808. In the absence of an embedded game trigger, the process continues to complete the feature game as indicated at process block 809, award the total prize for the feature game as indicated at process block 810, and then return to the primary game as indicated at process block 812.

It should be noted that any suitable arrangement may be used to trigger the feature game in accordance with decision box 802 and trigger the embedded bonus game in accordance with decision box 808. For example, the feature game may be triggered in response to a particular outcome in the primary game. This outcome may be obtained randomly or in any suitable fashion. The embedded game trigger may include, for example, a particular occurrence in the course of the feature game. In the feature game illustrated in FIG. 1A for example, the embedded game may be triggered when the object 107 interacts with (is caught by) ball catcher 115. However, the present invention is not limited by any particular interaction with object 107 to trigger the embedded bonus game, nor is the invention limited to interaction-type triggers for the embedded bonus game. For example, the embedded bonus game may be triggered randomly or according to some schedule, without any interaction between visual elements of the feature game.

In the event the embedded bonus game is triggered as indicated by the affirmative outcome at decision box 808, the process branches to first select an embedded game as indicated at process block 815. This selection step may select from a single embedded game with different skins, that is, graphic presentations, or may select from between substantively different games. The selection may be random or performed in any other way, including by player selection, for example. In any event, once the embedded game is selected, the process includes conducting the embedded game as indicated at process block 816. Once the embedded game is complete, as indicated by the affirmative outcome at decision box 818, the process branches back to complete the feature game. Otherwise, if the embedded game is not complete, the process loops back to continue conducting the embedded game. In some forms of the present invention, the embedded bonus game may be presented through the same display device which presents the feature game. For example, the embedded bonus game may be presented in a popup window in the area of a display device used to present the feature game. Alternatively, the embedded bonus game may replace all or a portion of the feature game graphic, perhaps with some remaining graphic features of the feature game show muted or in the background of the embedded bonus game presentation.

It should be noted that the steps included in awarding the total prize as indicated at process block 810 in FIG. 8 will depend upon whether the embedded game is conducted or just the feature game. If the embedded game is conducted, the total prize will include a feature game component comprising a value obtained in the feature game, and an embedded game component comprising a value, if any, obtained in the course of conducting the embedded game.

In one preferred implementation of the feature game and embedded bonus game, a multiplier may be available in the portion of the feature game conducted prior to branching to conduct the embedded game. In this implementation, the multiplier obtained in the course of the feature game conducted before the embedded game applies not only to the remainder of the feature game but also to the embedded game. It is also possible to award a multiplier in the embedded bonus game which then applies to awards in the remainder or all of the feature game.

It will be appreciated that the process illustrated in FIG. 8 may be performed by one or more general purpose data processing devices executing computer program code. In particular, a processor associated with a gaming machine may execute player input program code to receive primary game inputs from a player and any player inputs needed in the course of the feature game or embedded bonus game. The primary game may be conducted under the control of primary game program code executed by a suitable processor such as CPU or game processor 501 in FIG. 5. Process steps associated with conducting the embedded bonus game (blocks 815, 816, and 818 in FIG. 8) may be performed under the control of embedded bonus game program code, and feature game program code may be executed to perform the steps associated with the feature game, including the steps indicated at 802, 804, 805, 808, 809, 810, and 812 in FIG. 8.

It should also be appreciated that many variations on the process illustrated in FIG. 8 are possible within the scope of the present invention. For example, the feature game skin selection step at process block 804 and the embedded game selection step at block 815 may be performed prior to the point noted in the figure. Yet other alternatives will include no alternative skins for the feature game and/or alternative game types for the embedded bonus game.

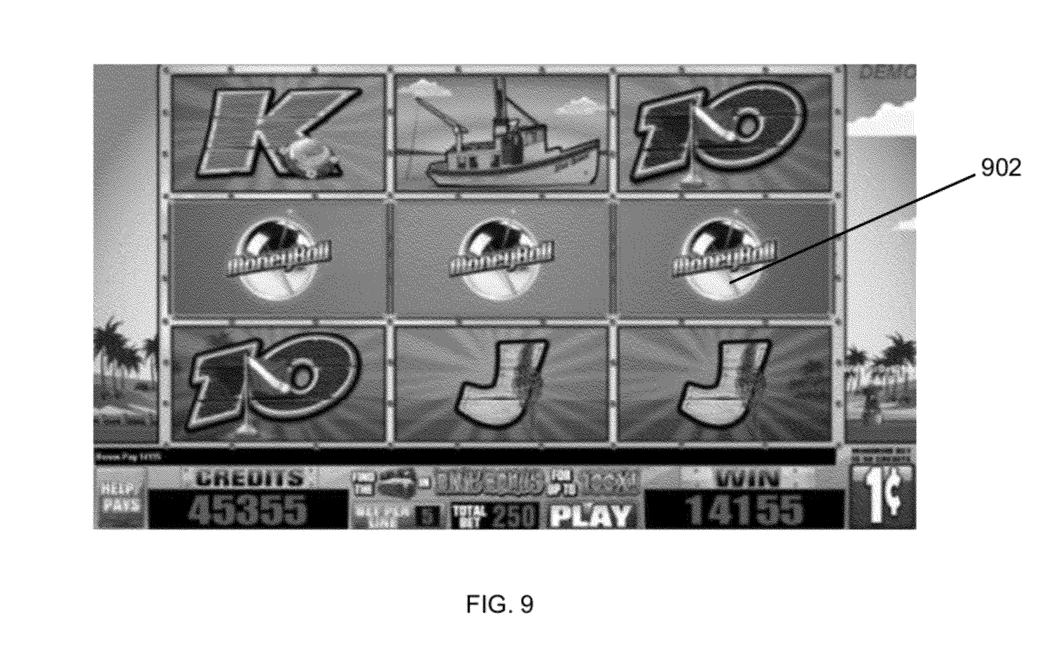

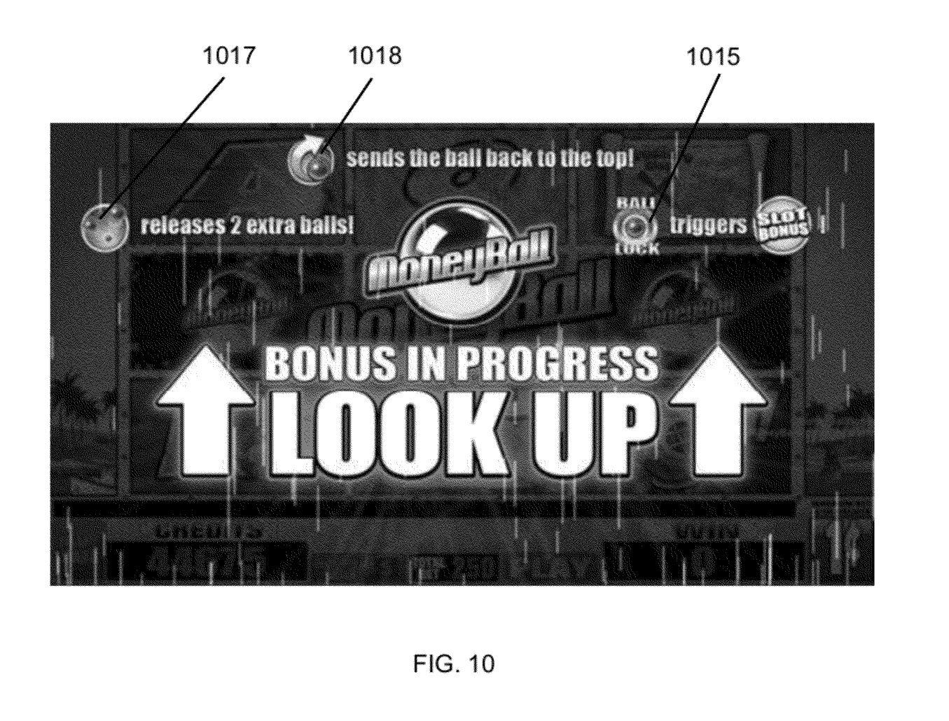

FIG. 9 shows an example display which may be produced in a primary game. In this example, the display is shown in a configuration representing a trigger for the feature game. In this particular sample, the feature game trigger comprises matching special symbols the “MoneyBall” symbols 902 along a pay line of the primary game. In response to this trigger, some implementations of the invention cause the display area which displayed the primary game to change to a message display. An example message display is shown in FIG. 10. This message display includes information regarding the feature game which has been triggered and also includes a message to direct the player to look to the display device through which the feature game will be presented. In this particular case, the feature game will be presented on a display device located above the display device which shows the primary game. The information included in the graphic shown in FIG. 10 therefore directs the player to look up to see the feature game. The information included in the message display may also include an explanation of characteristics of the feature game. For example, the image shown in FIG. 10 includes a graphic element 1017 which, when invoked during the feature game, releases multiple extra balls into the feature game field. Another graphic symbol, symbol 1018, may operate in the course of the feature game to send the ball back to the top of the feature game field. Another graphic element illustrated in FIG. 10 is a ball lock trigger 1015 which, when invoked in the feature game, triggers the embedded bonus game.

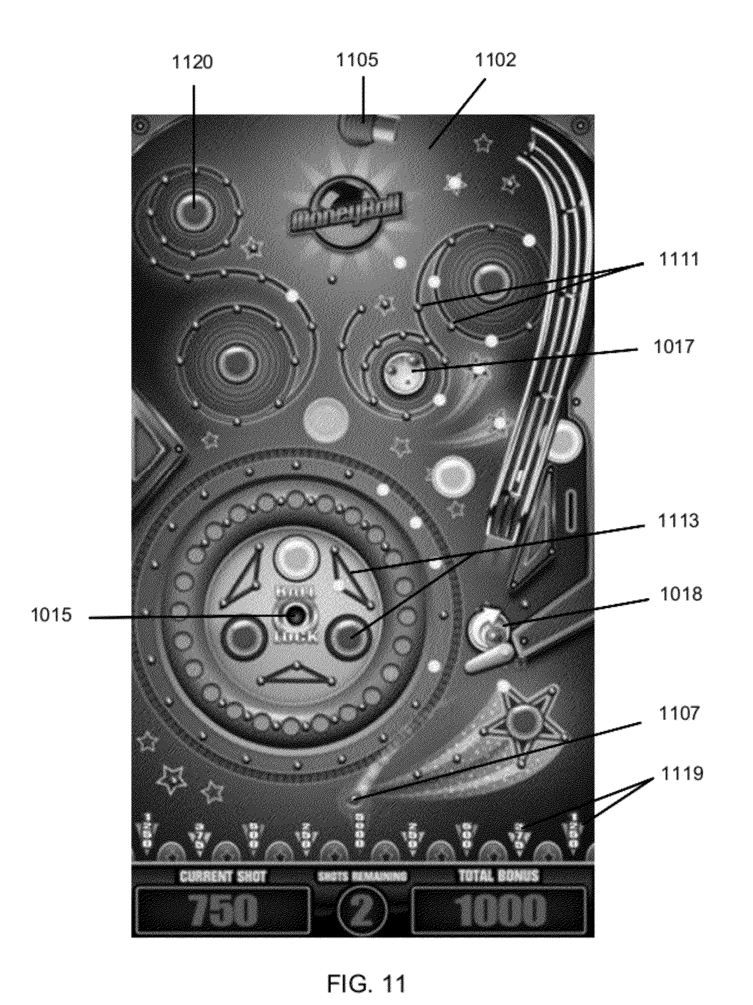

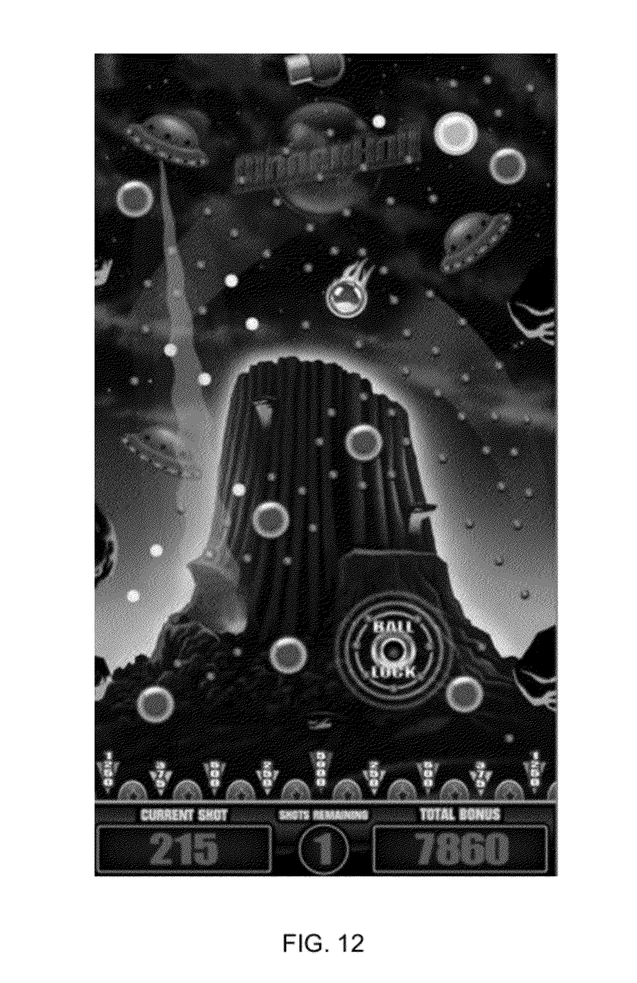

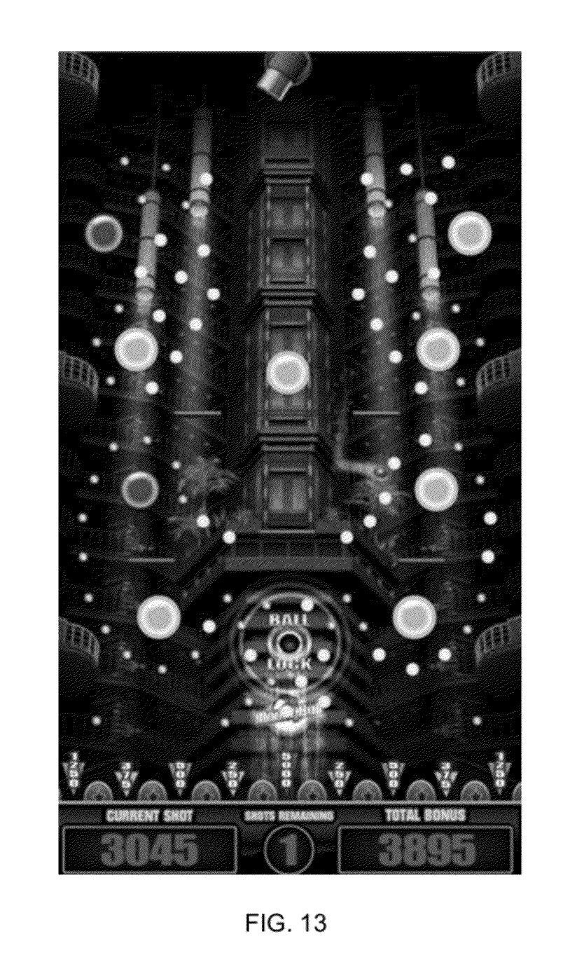

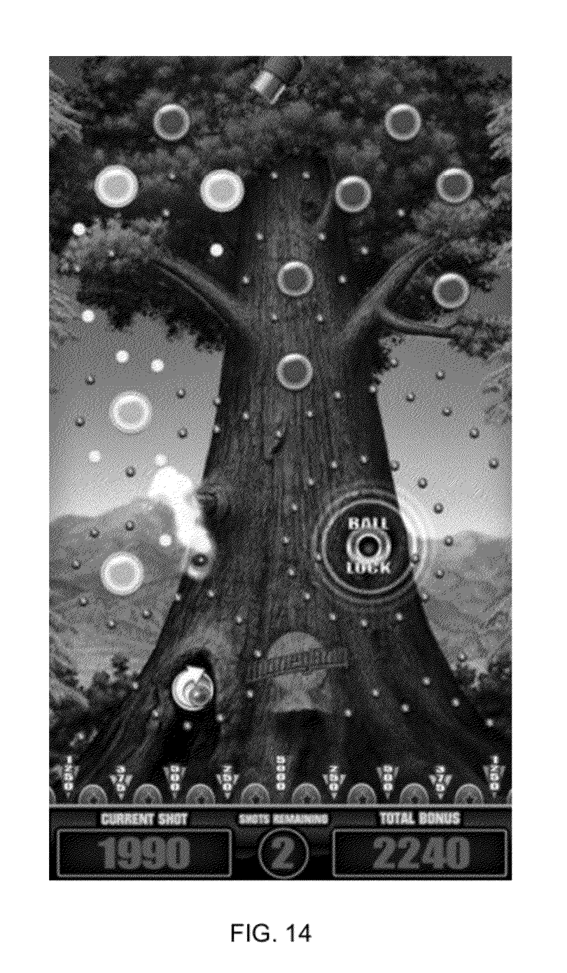

FIGS. 11, 12, 13, and 14 illustrate examples of different skins which may be employed for a feature game conducted in accordance with the present invention. One of these skins may be selected according to the feature game skin selection step shown at process block 804 in FIG. 8. Each of these feature game skins is similar to the feature game described above in connection with FIG. 1A. In particular, with particular reference to FIG. 11, a ball 1107 is launched from a launcher 1105 at the top of a field 1102 and points (credits) are accumulated as the ball interacts with various features included in the illustrated field. FIG. 11 shows pins 1111, bumpers 1113, multiple ball launcher 1017, return launcher 1018 and ball catcher 1015 which the ball 1107 may hit. FIG. 11 also shows features 1120 which may award a credit value when the ball 1107 passes over the feature. The graphic shown in FIG. 11 also includes buckets or chutes 1119, each associated with a credit value which is awarded if the ball 1107 exits the field there through. It should be noted that while the various features are not labeled in FIGS. 12, 13, and 14, each of these figures includes graphic features similar to those labeled in FIG. 11.

It will be appreciated that since the call catcher 1015 in FIG. 11 represents the trigger for the embedded bonus game, the feature game may be suspended in a state in which the ball 1107 is caught in the ball catcher. Once the feature game resumes after completion of the embedded bonus game, the feature game may show the ball 1107 being released in some fashion from ball catcher 1015.

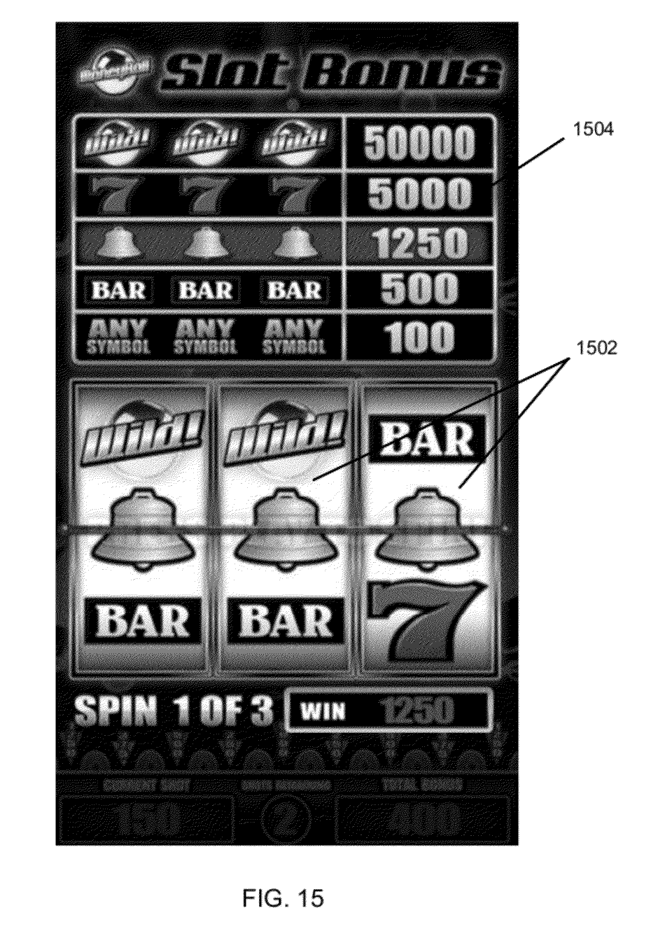

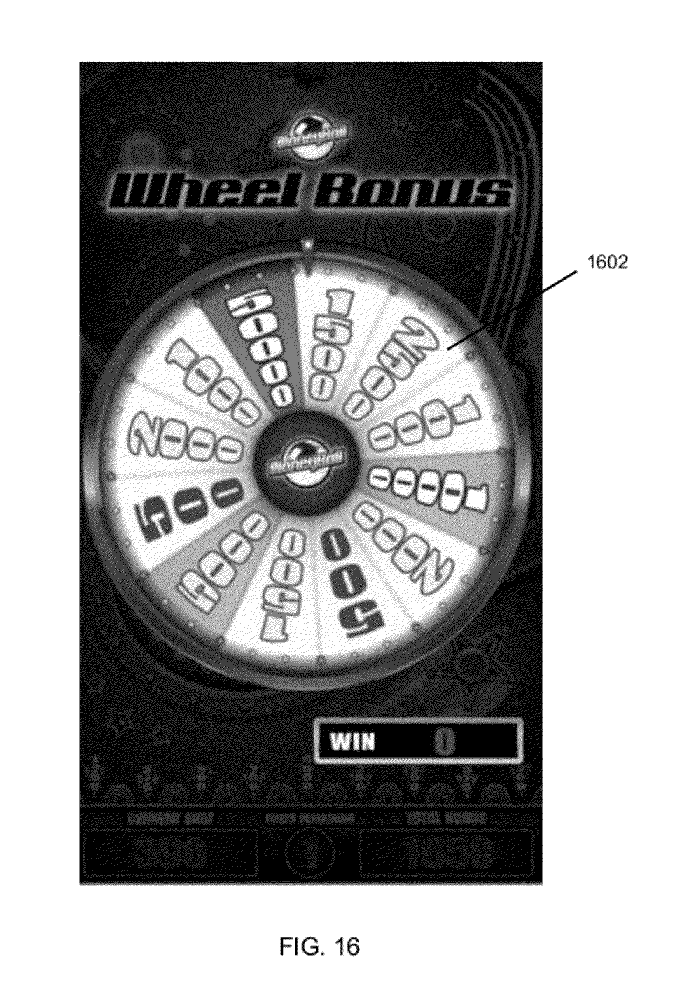

FIGS. 15 and 16 show two different embedded game types which may be selected according to the step shown at process block 815 in FIG. 8. FIG. 15 shows a reel-type game conducted with three simulated spinning reels 1502, and having a pay table 1504 shown in the upper portion of the graphic. This particular example provides a player three spins of the reels 1502 to collect points or credits for the embedded game. These spins may be conducted automatically without intervention by the player or may be conducted in response to a spin or play input which must be entered by the player. It will be appreciated that in FIG. 15, the reel-type display is essentially displayed over the area previously used for the feature game. That is, the reel-type game shown in FIG. 15 is displayed over the graphic for the feature game, and in this example, leaving some elements of the feature game visible through the graphic of the reel-type game.

FIG. 16 shows an alternate embedded bonus game which may be selected in the selection step shown at process block 815 in FIG. 8. This particular game comprises a wheel-spin game employing a prize wheel 1602. As in the reel-type game shown in FIG. 15, the wheel-spin embedded bonus game may initiate a spin of the wheel in response to some action by the player at the gaming machine or may initiate a spin of the wheel automatically without any input from the player.

The awards obtained in the feature games described above in connection with the flow chart of FIG. 8 may be generated in any of the fashions described for the feature game shown in FIG. 1A, or in any other fashion. The awards obtained in the embedded bonus game may also be obtained in any suitable fashion, including by a random number generator process, by random reel or wheel stop process, by drawing a lottery record from a lottery record set, or by obtaining a bingo result from a bingo game for example. Where multiple plays of the embedded bonus game are possible, such as by multiple spins of reels or spins of a prize wheel, a result may be obtained for each spin, or a single result may be obtained for all spins and then the spins controlled to show a total comprising the award amount associated with the single result.

It will be noted with reference to the two alternative embedded bonus games shown in FIGS. 15 and 16, that one or more of the prizes available in the embedded game may be a substantial prize, such as 50,000 credits in both examples. The availability of such a large prize in the embedded bonus game may help generate player interest and excitement in the embedded bonus game. However, other embodiments of an embedded bonus game may use relatively smaller prizes, more in line with those offered by object (107 in FIG. 1A, 1107 in FIG. 11) interactions in the feature game.

Referring generally to the forgoing description, as used herein the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described example embodiments are intended to illustrate the principles of the invention, but not to limit the scope of the invention. Various other embodiments and modifications to these preferred embodiments may be made by those skilled in the art without departing from the scope of the present invention.

For example, gaming machines 103 as contemplated herein may be configured as Class II gaming machines. In the case of Class II gaming devices, the overall structure of the various devices as discussed above is essentially the same with the major difference being the method of determining the game outcome. Commonly, Class II gaming devices utilize the game of bingo as the basis for determining a winning outcome where the ball draw is performed remotely by a network or central determination server (alternative games may be used for determining game outcomes, such as through a lottery drawing of a finite set of numbers, if permitted by the licensing authority in the given jurisdiction). Class II gaming systems are commonly referred to as central determination systems wherein pools and sub-pools of game outcomes are determined by a central server (or gaming device) and distributed amongst a set of networked gaming devices. The distribution step may be on demand, such as when a gaming device receives a game request, or sets of game outcomes may be distributed to the various networked gaming devices in which case the game processor of the requesting gaming device may select a game outcome from the set of game outcomes, such as by using an RNG or other selection process.

Class II gaming devices, such as a bingo-based gaming device, may have multiple display devices to display one or more electronic bingo cards and one or more ball drawings after a game has been initiated in accordance with the game outcome that has been provided to the gaming machine by a central determination server. Where the primary display comprises a set of reels (such as display 301 in FIG. 3), the game processor for the gaming machine (such as CPU 501 in FIG. 5) may convert the centrally-determined game outcome to a corresponding value outcome of the reel-based game as shown in FIG. 3 and operates the reel-based game as described above and with respect to those figures. In another embodiment, the central determination server may perform the conversion and send the corresponding reel-based game outcome and bingo outcome. Similarly, as described above, the player may wager a side bet to qualify for the community game. Once the community game is initiated, play may commence in the same manner as described above with respect to the figures, particularly FIG. 2, except that the RNG operation of determining a launch velocity at a player-selected launch angle may be performed by a central determination server in which case the central determination server may randomly obtain a velocity from a finite pool of velocities, and/or with associated prizes.

In another example alternative embodiment, the primary wagering game presented to the player and displayed, such as on display 305 in FIG. 3, may be a video poker, blackjack, roulette or other video table, card, or wagering game.

1. A method of operating a gaming machine, the method including:
(a) receiving one or more primary game inputs through the gaming machine to initiate one or more plays of a primary game presented at the gaming machine;
(b) after the one or more plays of the primary game are presented at the gaming machine, initiating a feature game and presenting the feature game at the gaming machine through a display device included with the gaming machine;
(c) in response to a triggering event in the feature game and prior to completion of the feature game, initiating an embedded bonus game and presenting the embedded bonus game through the display device, the presentation of the embedded bonus game being visually distinct from the presentation of the feature game;
(d) upon completion of the embedded bonus game, presenting a remainder of the feature game through the display device; and
(e) awarding a total prize for the feature game and embedded bonus game, the total prize being made up of a feature game prize component obtained in the presentation of the feature game and an embedded bonus game prize component obtained in the presentation of the embedded bonus game.

2. The method of claim 1 wherein the feature game includes two or more distinct visual configurations and further including selecting one of the two or more distinct visual configurations to be used in presenting the feature game, the selection being performed by a processing device associated with or in communication with the gaming machine.

3. The method of claim 1 further including selecting the embedded bonus game from two or more distinct game types, the selection being performed by a processing device associated with or in communication with the gaming machine.

4. The method of claim 1 further including invoking a feature game multiplier in the course of presenting the feature game prior to initiating the embedded bonus game, and applying the feature game multiplier to one or more results in the embedded bonus game to obtain the embedded bonus game prize component.

5. The method of claim 1 wherein the display device is mounted on the gaming machine above a primary display device and wherein the one or more plays of the primary game are presented through the primary display device.

6. The method of claim 5 further including displaying a feature game message on the primary display device in coordination with initiating the feature game, the feature game message directing an observer's gaze upward toward the display device.

7. The method of claim 1:
(a) wherein each outcome of the feature game is defined by a function of at least two independent variables and wherein each respective outcome is associated with a respective probability of obtaining that outcome such that the feature game provides a spectrum of feature game outcome probabilities; and
(b) further including setting a respective value for each of the at least two independent variables, wherein the value set for at least one of the at least two independent variables is dictated by a player selection received through the gaming machine, and wherein the value set for at least one of the at least two independent variables is determined randomly or pseudo-randomly.

8. A gaming system including:
(a) one or more display devices;
(b) a player input system;
(c) at least one processor; and
(d) at least one memory device storing instructions executable by the at least one processor to:
(i) receive one or more primary game inputs through the player input system to initiate one or more plays of a primary game;
(ii) after the one or more plays of the primary game, initiate a feature game so that an initial portion of the feature game is presented through at least one of the one or more display devices;
(iii) in response to a triggering event in the feature game and prior to completion of the feature game, initiating an embedded bonus game so that the embedded bonus game is presented through the at least one of the one or more display devices, the embedded bonus game having a graphic presentation which is visually distinct from a graphic presentation of the feature game;
(iv) upon completion of the embedded bonus game, causing a remainder of the feature game to be presented through the at least one of the one or more display devices; and
(v) cause a total prize to be awarded for the feature game and embedded bonus game, the total prize being made up of a feature game prize component obtained in the presentation of the feature game and an embedded bonus game prize component obtained in the presentation of the embedded bonus game.

9. The gaming system of claim 8 wherein the feature game includes two or more distinct visual configurations and wherein the at least one memory device stores instructions executable by the at least one processor to select one of the two or more distinct visual configurations to be used in presenting the feature game.

10. The gaming system of claim 8 wherein the at least one memory device stores instructions executable by the at least one processor to select the embedded bonus game from two or more distinct game types.

11. The gaming system of claim 8 wherein the at least one memory device stores instructions executable by the at least one processor to invoke a feature game multiplier in the course of presenting the feature game prior to initiating the embedded bonus game, and to apply the feature game multiplier to one or more results in the embedded bonus game to obtain the embedded bonus game prize component.

12. The gaming system of claim 8 wherein both the feature game and the embedded bonus game are presented on a first one of the one or more display devices and wherein the one or more plays of the primary game are presented through the second one of the one or more display devices, the second one of the one or more display devices being mounted below the first one of the one or more display devices.

13. The gaming system of claim 12 wherein the at least one memory device stores instructions executable by the at least one processor to cause the second one of the one or more display devices to display a feature game message on the primary display device in coordination with initiating the feature game, the feature game message directing an observer's gaze upward toward the first one of the one or more display devices.

14. The gaming system of claim 7 wherein:
(a) each outcome of the feature game is defined by a function of at least two independent variables and wherein each respective outcome is associated with a respective probability of obtaining that outcome such that the feature game provides a spectrum of feature game outcome probabilities; and
(b) the at least one memory device stores instructions executable by the at least one processor to set a respective value for each of the at least two independent variables, wherein the value set for at least one of the at least two independent variables is dictated by a player selection received through the gaming machine, and wherein the value set for at least one of the at least two independent variables is determined randomly or pseudo-randomly.

15. A program product stored on one or more data storage devices, the program product including:
(a) player input program code executable to receive a respective primary game input through a gaming machine;
(b) primary game program code executable to initiate one or more plays of a primary game in response to each respective primary game input;
(c) embedded bonus game program code executable to initiate an embedded bonus game and present the embedded bonus game at the gaming machine, the embedded bonus game being initiated after initiation of a feature game at the gaming machine but prior to completion of the feature game; and
(d) feature game program code executable to:
(i) initiate and begin presenting a feature game after the one or more plays of the primary game;
(ii) suspend the feature game upon initiation of the embedded bonus game;
(iii) upon completion of the embedded bonus game, continue presenting the feature game from the point at which it was suspended; and
(iv) determine a total prize for the feature game and embedded bonus game, the total prize being made up of a feature game prize component obtained in the presentation of the feature game and an embedded bonus game prize component obtained in the presentation of the embedded bonus game.

16. The program product of claim 15 wherein the feature game program code is also executable to select one of two or more distinct visual configurations to be used in presenting the feature game.

17. The program product of claim 15 wherein the embedded bonus game program code is also executable to select from two or more distinct game types for the embedded bonus game.

18. The program product of claim 15 wherein the embedded bonus game program code is also executable to apply a feature game multiplier to one or more results in the embedded bonus game to obtain the embedded bonus game prize component, the feature game multiplier comprising a multiplier which has been invoked in the presentation of the feature game prior to initiation of the embedded bonus game.

19. The program product of claim 15 wherein the feature game program code is executable to cause the feature game to be presented on a first display device mounted on the gaming machine and wherein the primary game program code is executable to cause the primary game plays to be presented through a primary display device mounted below the first display device.

20. The program product of claim 19 wherein the primary game program code is executable to cause a feature game message to be displayed on the primary display device in coordination with initiation of the feature game, the feature game message directing an observer's gaze upward toward the first display device.
